(19) United States
(12) Patent Application Publication
(10) Pub. No.: US 2009/0169063 A1
(43) Pub. Date: Jul. 2, 2009

(54) FINGERPRINTING MEANS AND FINGERPRINTING SYSTEM

(76) Inventor: Takashi Kuraishi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/090,171

(22) PCT Filed: Oct. 12, 2005
(86) PCT No.: PCT/JP2005/018760

§ 371 Date: Apr. 14, 2008

(51) Int. Cl. G06K 9/00

(52) U.S. Cl. 382/116

(57) ABSTRACT

A fingerprinting technique of taking a left fingerprint, storing the taken fingerprint, and physically recording/storing information collected when the fingerprint is taken so as to add a physical evidence adoption capability. Fingerprinting means comprises a fingerprinting section (11) adapted for taking a fingerprint and composed of an adhesive layer or a layer (111) made of a substance to which ridges of a fingerprint can be transferred and a data recording section (12) provided in association with the fingerprinting section (11) and adapted for recording various information on the person having the fingerprint. The fingerprinting section (11) and the data recording section (12) are provided on the same base (1) and the covered with a protective film (13).

### TECHNICAL FIELD

The present invention relates to a fingerprinting technique for identification.

### BACKGROUND ART

A technique of taking a fingerprint and performing identification is anticipated to be used in a wide range of fields such as the identification when people enter or leave specific spaces such as a room, a hall, a place, a park and an office, at the time of management of attendance, and at the time of issuing official certificate documents; verification of persons in charge of handling personal information or verification of outsiders who examine and consult the personal information, in public institutions; verification of persons in charge of handling important information such as customer information, company information and drawing information in general companies; and verification whether or not users of facilities, devices, apparatuses or systems are authorized persons.

As fingerprint pattern taking techniques for performing fingerprint matching, there are mainly a capacitance detection type, an optical type, a pressure sensitive type and the like. All of these techniques are techniques intended to directly image the fingerprint of a fingertip. Therefore, in these techniques, a quality of an obtained image depends on a state of a surface of the fingertip, which has an effect on the matching itself. For example, in the above described respective techniques, the fingerprint matching with respect to a finger referred to as “dry finger” or a person having a thin fingerprint has been virtually difficult, and such a person has not been conforming as a person subjected to the matching.

Furthermore, in the above described identification techniques, a finger pattern is shot by necessarily touching the finger at the same position of the same sensor on which an unspecified large number of people touch. Therefore, dirt has been accumulated on the sensor so that the people may hesitate to touch the sensor, giving an impression of dirtiness to the people, which has been a problem.

The above described problems have been solved by a technique of “a card user identification system comprising a card including a data recording unit for recording data and an impressing member adhering portion to which a fingerprint impressing member used for impressing the fingerprint of a card user at the time of use of the card is removably adhered, and a card reader, wherein the card reader comprises fingerprint impressing member adhering means, fingerprint impressing member removing means, and fingerprint reading means; and the card user identification system removably adheres the fingerprint impressing member to the impressing member adhering portion of the card being inserted into the card reader, ejects the card from the card reader once, prompting the card user to reinsert the card having his/her fingerprint being imprinted on the fingerprint impressing member into the card reader, reads the fingerprint pattern of the card user from the fingerprint impressing member of the card being reinserted, confirms that a cardholder coincides with the card user using fingerprint data of the card user being read and fingerprint data of the cardholder being registered in advance, and removes the fingerprint impressing member from the card and ejects the card when the process of confirming the coincidence of the card user is finished”, proposed by the present applicant (see Patent Documents 1 and 2). However, a matching result is still only recorded as digital data.

Since the digital data is nothing more than an electric signal and a person having a required capability can tamper or destroy the digital data in any wise, vulnerability of the digital data as an evidence adoption capability has been pointed. This problem is not limited to the fingerprint matching, and also is a challenge common to all products, devices and systems using biometrics.

Originally, as a reason for performing matching of an identical person by using the biometrics including the fingerprint, the biometrics has been used as means of verifying that a person is surely the identical person and increasing security level. However, when there is still a possibility that tampering is performed in its matching result or in a process of obtaining the matching result, an original purpose of security is not satisfied.

Patent Document 1: Japanese Patent No. 3367606

Patent Document 2: EP1291825A1

In view of the above described problem, in a fingerprinting technique, it is an object of the present invention to provide highly accurate identification means by obtaining a steady and clear image without depending on the state of the surface of the fingertip, to provide means capable of taking the fingerprint without giving the impression of dirtiness to the person subjected to the matching, and also to provide fingerprinting means and a fingerprinting device adapted for storing a left fingerprint taken by being transferred, and physically recording/storing information collected when the fingerprint is taken so as to add a physical evidence adoption capability.

### DISCLOSURE OF THE INVENTION

In order to solve the above described problem, as means of taking a fingerprint pattern and matching it, the present invention configures fingerprinting means by integrating a fingerprinting technique proposed in the above described Patent Document 1, that is, a fingerprinting section in which a sticker or a tape which forms an adhesive layer having an appropriate adhesive force or a layer made of a substance to which ridges of a fingerprint can be transferred is used, a finger is pressed on the sticker or the tape and transferred, and a fingerprint pattern is taken, and an information recording section in which data collected when the fingerprint has been taken has been recorded.

In the present invention, in the above described fingerprinting means, when the fingerprint has been taken and matching has been completed, necessary data is recorded in the information recording section, and the fingerprinting section and the information recording section are sealed by a protective sticker or tape so that the taken fingerprint pattern and the recorded data may not be tampered, attached with foreign substances such as dust, or harmed. Thereby, a process of enabling long-term storage is applied.

As means of recording information, the present invention prints out necessary information as character strings, or prints the necessary information in an encrypted state by using barcodes, two-dimensional codes (QR codes) or the like, in the information recording section. Furthermore, in the present invention, in consideration of easier search, it is also possible to previously, separately and additionally write a serial number, identification means or the like in the information recording section.

In the present invention, it is also possible to apply anticounterfeit measures which have been normally employed, to the sticker or the tape, in order to secure that the sticker or the tape itself has not been counterfeited. Moreover, in the present invention, for example, it is also possible to previously bury a powder IC chip such as “μchip” manufactured by Hitachi, Ltd. in the information recording section of the sticker or the tape.

In the present invention, the fingerprinting section and the information recording section can also be alternately configured and formed in a consecutive tape shape so that they appear repetitively.

In the present invention, an adhesive substance or the substance to which the ridges of the fingerprint can be transferred (hereinafter referred to as “adhesive substance”), which is used for the fingerprinting section adapted for taking the fingerprint pattern, has appropriate adhesion. In addition, it is possible to cause the adhesive substance to have a function of fixing the fingerprint pattern by applying a light cured resin onto a base, further coating the light cured resin with an adhesive tape and exposing them to light to be cured, and a function of fixing the fingerprint pattern by mixing and kneading a thermoset resin with the adhesive substance and heating them to be cured and the like. Moreover, it is also possible to improve visibility of the fingerprint pattern by mixing and kneading a fluorescent substance with the same adhesive substance and illuminating black light to them.

In the present invention, in the fingerprinting section adapted for taking the fingerprint pattern, it is also possible to take the fingerprint by transferring the fingerprint to a metallic foil made of iron or the like with a mirror finished surface, a photographic film which is exposed in an ultraviolet region, or the like, in addition to the adhesive substance.

In the present invention, the protective sticker or tape has also an appropriate bonding force for performing the sealing. In addition, for the purpose of causing the fingerprint pattern to be colored so that the fingerprint can be easily and visually verified when the taken fingerprint has been sealed, it is also possible to compound various addition agents, for example, a reagent reacting with proteins or amino acids, such as ninhydrin, to a base of the same adhesive substance.

In the present invention, means of taking and matching the fingerprint has been solved by the means of Patent Document 1. Furthermore, the information recording section adapted for storing a transferred fingerprint pattern as a left fingerprint over long periods and also recording various information collected when the fingerprint is taken is integrated with the means of taking and matching the fingerprint, and they are sealed by using the protective sticker or tape and thereby protected from fraudulent acts such as the tampering. Therefore, an evidence adoption capability has been significantly improved.

In the present invention, as shown in a first example, it has become possible to simultaneously verify the taken fingerprint pattern and the necessary data collected when the fingerprint is taken, by integrating the fingerprinting section and the information recording section.

In the present invention, as shown in a second example, the integration of the fingerprinting section and the information recording section is formed in the tape shape in order to cause it to consecutively and alternately appear, or a sticker in which the fingerprinting section and the information recording section have been integrated is collected by a consecutive protective tape. Thereby, since the fingerprinting section can perform the storage in a time-series manner, without interruption, and consecutively, the evidence adoption capability of the fingerprinting means is secured.

Consequently, the present invention can obtain a very high inhibiting effect against the fraudulent acts or criminal acts, which is an original purpose of security.

Conventionally, in the case of placing the fingerprint, it has been necessary to use a vermilion ink-pad or an ink. However, in the present invention, as shown in a third example, if the fingerprinting section is configured on a base such as a paper sheet and sealed with the protective sticker after the fingerprint is taken, it is possible to place the fingerprint without using the vermilion ink-pad or the ink, and it is possible to place the fingerprint without staining a fingertip according to the present invention. Moreover, by using a method of the present invention, even when the fingerprint pattern is registered in a database, it also becomes unnecessary for a person subjected to the fingerprinting to step forward to a place where there is a registration apparatus. Furthermore, in the present invention, it is possible to separately apply the matching offline even in the case where it is difficult to perform the matching with respect to the person subjected to the fingerprinting when the fingerprint is taken, or in the case where it is not necessary to immediately perform the matching with respect to the person subjected to the fingerprinting on the moment but is necessary to verify the person at a later date.

In the present invention, what is taken by the adhesive substance is not limited to the fingerprint pattern, and it is also possible to take and secure secreted materials such as sweat, a piece of flaked skin and the like.

In the present invention, the fingerprinting section and the information recording section are covered with the protective sticker or tape applied with the adhesive substance, and both are sealed. Thereby, it is very difficult to tear off both stickers or tapes, and yet, the taken fingerprint pattern is destroyed when the sticker or the tape is torn off.

According to the present invention, it is possible to realize a method of correctly performing identification without giving an impression of dirtiness to the person subjected to the fingerprinting. Furthermore, according to the present invention, since the fingerprinting section and the information recording section at the time of fingerprinting are integrated, a matching result or the necessary information is also simultaneously and physically recorded, and it is possible to directly verify the fingerprint pattern and the information on the fingerprint. Moreover, according to the present invention, the fingerprinting section and the information recording section are integrated and formed in the consecutive tape shape, or in the case of the sticker shape, the consecutive protective tape for the collection is used. Thereby, since the taken fingerprint and the fingerprint data can be consecutively stored in a time-series manner, even if intermediate data extraction, fraudulent modification or tampering has been performed, it is immediately revealed, and therefore, the evidence adoption capability is further improved as a physical evidence.

### BRIEF DESCRIPTION OF THE DRAWINGS

FIG. 1 is a diagram illustrating a first example of fingerprinting means according to the present invention;

FIG. 2 is a diagram illustrating a second example of the fingerprinting means according to the present invention;

FIG. 3 is a diagram illustrating a third example of the fingerprinting means according to the present invention;

FIG. 4 is a diagram illustrating a fourth example of the fingerprinting means according to the present invention;

FIG. 5 is a diagram illustrating a fifth example of the fingerprinting means according to the present invention;

FIG. 6 is a diagram illustrating a protective sticker or tape for protecting a fingerprinting section and an information recording section according to the present invention;

FIG. 7 is a diagram illustrating a configuration of a fingerprinting system using the fingerprinting means according to the present invention; and

FIG. 8 is a diagram illustrating a tape running board in the second or third example of the fingerprinting means according to the present invention.

### DESCRIPTION OF SYMBOLS

1 Fingerprinting means
11 Fingerprinting section
111 Adhesive compound layer
12 Information recording section
121 Data track
13 Protective film
131 Adhesive compound layer
2 Fingerprinting means provided by forming the fingerprinting means 1 in a tape shape
3 Fingerprinting means provided by forming the fingerprinting means 1 on a base such as a paper sheet
71 ID input section
72 Fingerprint reading section
73 Fingerprint database
74 Comparison/matching section
75 Data output section
76 Print out device
81 Tape running board
82 Guide

### BEST MODE FOR CARRYING OUT THE INVENTION

An embodiment of the present invention has a fingerprinting section adapted for taking a fingerprint and composed of an adhesive layer or a layer made of a substance to which ridges of the fingerprint can be transferred, the adhesive layer or the layer being provided on a base such as a film or a paper sheet, and an information recording section provided in association with the fingerprinting section and adapted for recording various information on a person having the fingerprint. The fingerprinting section and the information recording section are provided on the same base.

Furthermore, in the present invention, in fingerprinting means, the base is formed in a tape shape in order to cause the fingerprinting section and the information recording section to consecutively appear. The fingerprinting section and the information recording section are alternately placed on the base in a longitudinal direction of the tape, or the fingerprinting section is sequentially placed on the base in the longitudinal direction of the tape and the information recording section is placed along with the fingerprinting section at an end of the tape in the longitudinal direction, or the information recording section is placed at a peripheral portion of the fingerprinting section. Moreover, in the present invention, in the above described fingerprinting means, the base is formed in a card shape, and the fingerprinting section and the information recording section are placed on the base in association with each other.

In the present invention, in the above described fingerprinting means, the fingerprinting section after taking the fingerprint, as well as the fingerprinting section and the information recording section are covered with a protective sticker or tape.

The present invention has fingerprinting means having a fingerprinting section adapted for taking a fingerprint and composed of an adhesive layer or a layer made of a substance to which ridges of the fingerprint can be transferred, the adhesive layer or the layer being provided on a base, and an information recording section provided in association with the fingerprinting section and adapted for recording various information on a person having the fingerprint, the fingerprinting section and the information recording section being provided on the same base; a fingerprint reading section adapted for reading a fingerprint pattern taken by the fingerprinting section in the fingerprinting means; a fingerprint database adapted for storing the information on the fingerprint; and a comparison/matching section adapted for verifying identity or non-identity by referring to the fingerprint database, based on the fingerprint information read by the fingerprint reading means.

An identification system using the fingerprinting means according to the present invention reads the fingerprint taken by the fingerprinting section, by image pickup means, matches the taken fingerprint with a fingerprint registered in the fingerprint database, and writes a result of the matching, date and time when the fingerprint is taken which are required by an administrator, data on an identical person, and the like in the information recording section. Thereby, the taken fingerprint and information on the person can be integrated.

### Example 1

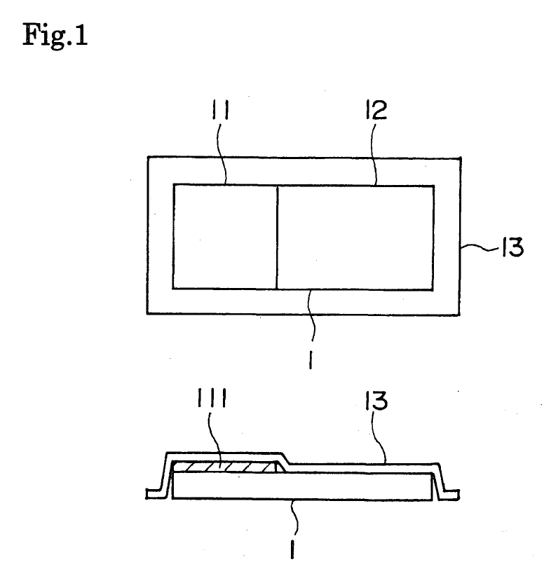

A configuration of the fingerprinting means according to a first example of the present invention will be described by using FIG. 1. An upper diagram in FIG. 1 is a top view of the fingerprinting means, and a lower diagram in FIG. 1 is a longitudinal sectional view of the fingerprinting means. This fingerprinting means is configured by providing a fingerprinting section 11 and an information recording section 12 in an integrated manner on a base 1 of a film shape. The base 1 of the film shape may be applied with coloring so that the fingerprint pattern for the matching may be more effectively shot. Moreover, for example, a white color may have been previously printed on the base 1 so that it may also be easy to visually verify information recorded in the information recording section 12. On the fingerprinting section 11, an adhesive compound layer 111 adapted for taking the fingerprint is provided, and after taking the fingerprint, it is possible to cover the fingerprinting section 11 with a protective film 13 to protect the taken fingerprint, and cover the information recording section 12 with the protective film 13 in order to prevent recording contents in the information recording section 12 from being tampered.

The information recording section 12 is provided in association with the fingerprinting section 11, and information required for identification, such as a data number, an ID number, the date and the time when the fingerprint is taken, the matching result, and a name of a person subjected to the matching, is recorded therein. The information written in the information recording section 12 can be characters, marks, facial photographs or the like of which contents can be visually recognized, or the information can be written as coded information such as barcodes which can be read by a reading device. For writing the information in the information recording section 12, it is possible to take a method of directly printing out the information by a normal printer or a barcode printer, a method of applying a light cured resin to the information recording section 12 and writing the information by a device for illuminating light of an appropriate wavelength, or a method of writing the information into an IC chip buried in a sticker or a tape.

### Example 2

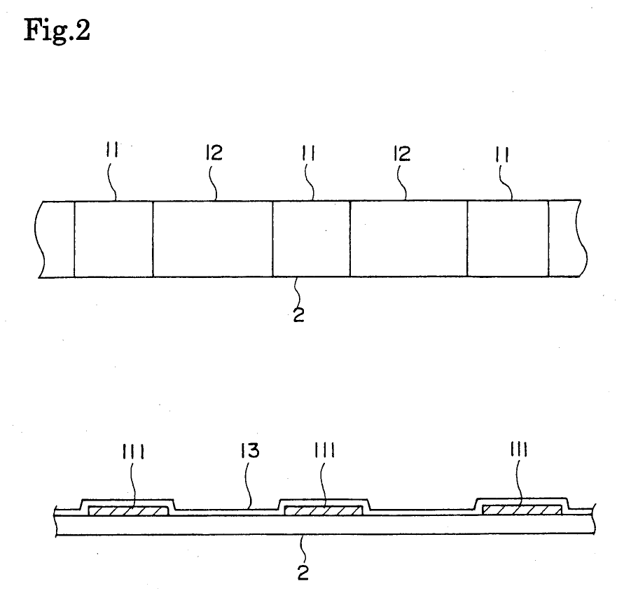

A second example of the present invention will be described by using FIG. 2. In this example, a sticker in which the fingerprinting section and the information recording section shown in the first example are integrated is formed in the tape shape so that the sticker may consecutively appear, and this example is configured so that the fingerprinting section 11 and the information recording section 12 are caused to alternately appear on a base 2 of the tape shape and covered with the protective film 13. The fingerprinting section 11 and the information recording section 12 are configured similarly to the first example.

### Example 3

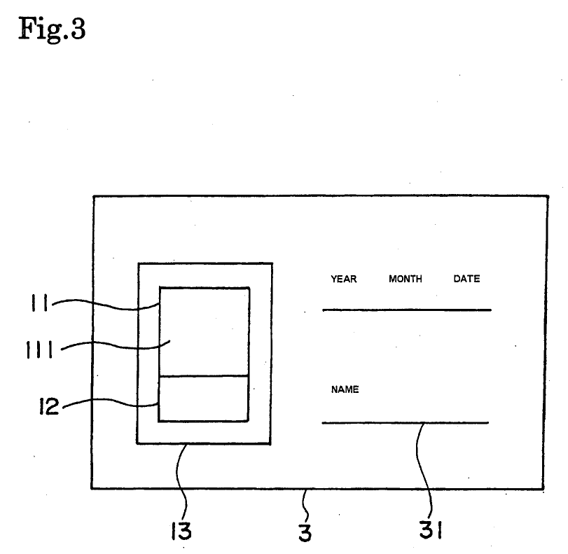

A third example of the present invention will be described by using FIG. 3. In this example, the fingerprinting section 11 is provided on a base 3 of the card shape, for example, using the paper sheet. On the fingerprinting section 11, the adhesive compound layer is provided similarly to the first example or the second example, and the fingerprinting section 11 is configured so that at least the adhesive compound layer on the fingerprinting section 11 is covered with the protective film 13. Information 31 such as the name of the person having the fingerprint or the date and the time when the fingerprint is taken is described on the base 3 of the card shape. By using such fingerprinting means, the fingerprinting means can be used as fingerprint placement means, and in addition, it is possible to separately apply the matching offline even in the case where it is not necessary to immediately perform the matching with respect to the person subjected to the fingerprinting on the moment but is necessary to verify the person at a later date, and the like.

### Example 4

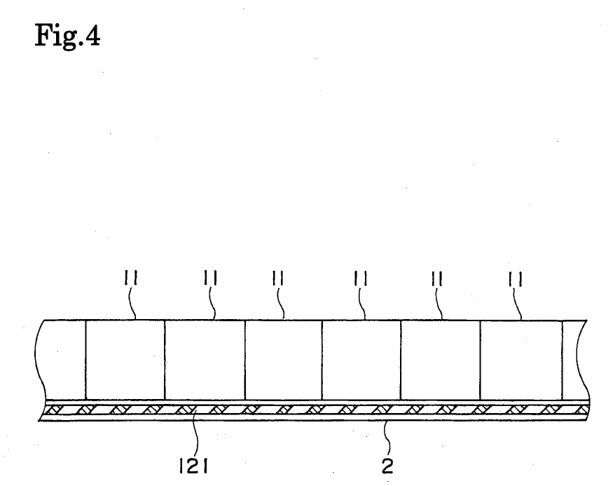

A fourth example of the present invention will be described by using FIG. 4. FIG. 4 is an example in which the fingerprinting section 11 is sequentially provided on the base 2 shown in the second example and also a data track 121 is provided as the information recording section 12 provided in a strip shape at an end of the base 2. The data track 121 can be a magnetic track, and contents of data recorded therein are similar to the first example. However, the contents of the data are written as magnetic data, correspondingly to the taken fingerprint. According to this example, data reading can be quickly performed and the taken fingerprint can be rapidly retrieved.

### Example 5

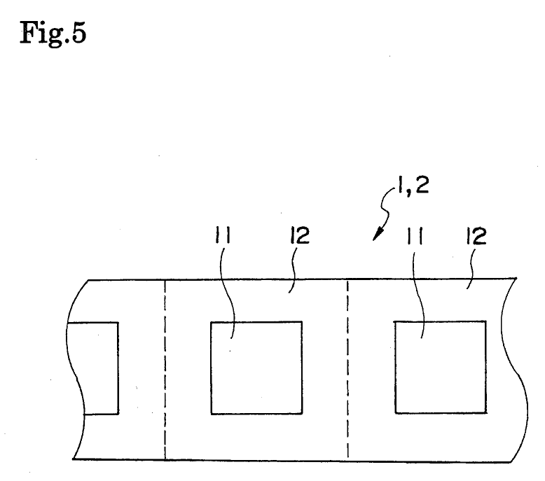

A fifth example of the present invention will be described by using FIG. 5. FIG. 5 is an example in which the information recording section 12 is placed around the fingerprinting section 11 on the base 1 or the base 2 shown in the first example or the second example.

### Example 6

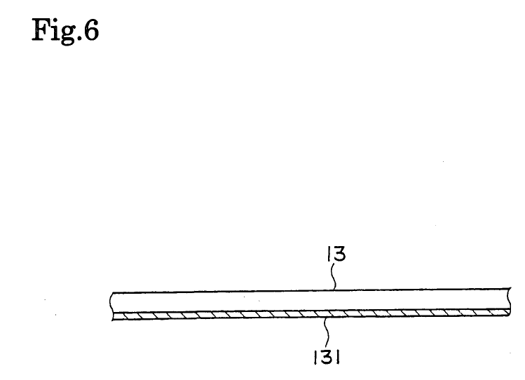

An example of the protective sticker or tape used in the present invention will be described by using FIG. 6. The protective sticker or tape 13 is configured by an adhesive layer having an appropriate adhesive force with respect to the film or a layer made of the substance to which the ridges of the fingerprint can be transferred 131. Moreover, it is also possible to compound various addition agents, for example, a reagent reacting with proteins or amino acids, such as ninhydrin, to the same adhesive layer or the layer made of the substance to which the ridges of the fingerprint can be transferred 131. Thereby, it is possible to cause the taken fingerprint pattern to color so that the taken fingerprint pattern can be easily and visually recognized. Furthermore, if a curing agent of a two-liquid mixed adhesive compound is used as a base of the adhesive layer or the layer made of the substance to which the ridges of the fingerprint can be transferred 131, a base resin is used as a base of the adhesive compound III used on the fingerprinting section 11, and both are bonded for sealing, it is possible to generate a stronger bonding force since two liquids react with each other to be cured, and it becomes very difficult to tear off both stickers or tapes.

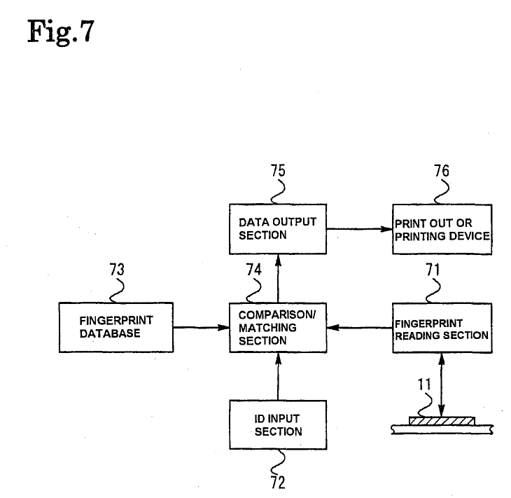

A configuration of an identification system using the fingerprinting means will be described by using FIG. 7. The identification system according to the present invention is configured by having a fingerprint reading section 71 adapted for reading the fingerprint which has been transferred and taken by the fingerprinting section 11 of the fingerprinting means, a fingerprint database 73 in which data on the fingerprint which has been previously taken or fingerprint data read this time and other information on the fingerprint data have been stored, a comparison/matching section 74 adapted for reading the fingerprint data which has been stored in the fingerprint database 73 by using the fingerprint read by the fingerprint reading section 71, and for performing comparison and the matching to verify the identity or the non-identity, a print out device 76 adapted for printing out or printing the various information to the information recording section 12 of the fingerprinting means, and a data output section 75 adapted for outputting the data to the print out device.

An ID input section 72 may be provided as appropriate or may be not required. The fingerprint database 73 may have been recorded on an IC on an IC card. The print out device 76 for necessary information such as an ID can write the information by means of directly printing out the information by the normal printer or the barcode printer, or by illuminating the light of the appropriate wavelength by the light illumination device to the data recording section 12 applied with the light cured resin.

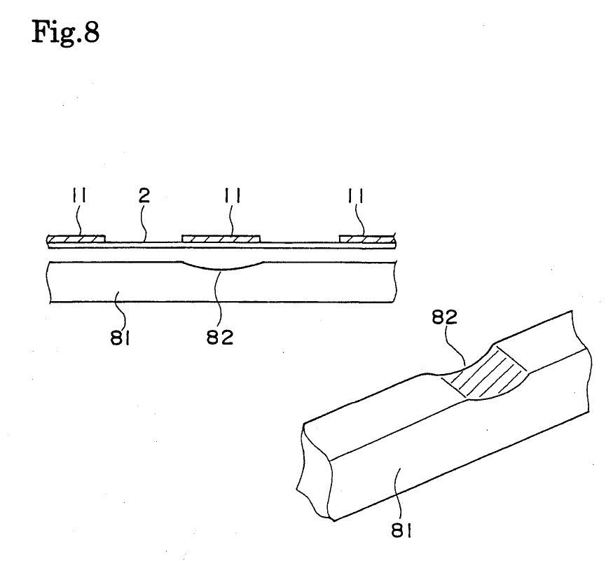

FIG. 8 is a diagram illustrating a shape of a tape running board used when the fingerprint is placed on the fingerprinting section in the case where the fingerprinting section and the information recording section have been integrated and formed in the tape shape as shown in the second example. In this example, in order to prevent a position of a finger on the tape shaped fingerprinting section from becoming unsteady and to prevent a placed fingerprint pattern from being displaced, a concave guide 82 has been provided on a portion on which the finger is depressed on the tape running board 81.

1. Fingerprinting means comprising:
a fingerprinting section adapted for taking a fingerprint and composed of an adhesive layer or a layer made of a substance to which ridges of the fingerprint can be transferred, the adhesive layer or the layer being provided on a base; and a data recording section provided in association with the fingerprinting section and adapted for recording various information on a person having the fingerprint, characterized in that sets of the fingerprinting section and the data recording section are provided on the same base formed in a tape shape.

2. The fingerprinting means according to claim 1, characterized in that the fingerprinting section and the data recording section are alternately placed on the base formed in a tape shape in a longitudinal direction of the tape.

3. The fingerprinting means according to claim 1, characterized in that the fingerprinting section is sequentially placed on the base formed in a tape shape in a longitudinal direction of the tape, and the data recording section is placed along with the fingerprinting section at an end of the same tape in the longitudinal direction.

4. (canceled)

5. The fingerprinting means according to claim 1, characterized in that the fingerprinting section and the data recording section are alternately placed on the same base formed in a tape shape in a longitudinal direction of the tape, and the fingerprinting section after taking the fingerprint is covered with a protective film.

6. The fingerprinting means according to claim 1, characterized in that the fingerprinting section is sequentially placed on the base formed in a tape shape in a longitudinal direction of the tape, the data recording section is placed along with the fingerprinting section at an end of the same tape in the longitudinal direction, and the fingerprinting section after taking the fingerprint is covered with a protective film.

7. (canceled)

8. A fingerprinting system characterized by comprising:
fingerprinting means having a fingerprinting section adapted for taking a fingerprint and composed of an adhesive layer or a layer made of a substance to which ridges of a fingerprint can be transferred, the adhesive layer or the layer being provided on a base, and a data recording section provided in association with the fingerprinting section and adapted for recording various information on a person having the fingerprint, sets of the fingerprinting section and the data recording section being provided on the same base formed in a tape shape;
a fingerprint reading section adapted for reading information on the fingerprint taken by the fingerprinting section in the fingerprinting means;
a fingerprint database adapted for storing the information on the fingerprint; and
a comparison/matching section adapted for finding an identical fingerprint by referring to the fingerprint database, based on the fingerprint information read by the fingerprint reading means.
